(19) United States
(12) Patent Application Publication
(10) Pub. No.: US 2025/0340736 A1
(43) Pub. Date: Nov. 6, 2025

(54) CRITTER RESISTANT ELECTRICAL CONTROL BOX FOR USE OUTDOORS

(71) Applicant: CorrSolve Corrosion Solutions, LLC, Fort Worth, TX (US)

(72) Inventors: Steven Tosh, Aledo, TX (US); Leonel Rodriguez, Arlington, TX (US); Chad Knight, Dodd City, TX (US); Michael Dry, Fort Worth, TX (US); Jeff Busby, Millsap, TX (US)

(21) Appl. No.: 19/272,724

(22) Filed: Jul. 17, 2025

Related U.S. Application Data
(63) Continuation of application No. 18/394,210, filed on Dec. 22, 2023.
Application No. 18/394,210 is a continuation of application No. 17/065,692, filed on Oct. 8, 2020, now abandoned.
(60) Provisional application No. 62/887,318, filed on Aug. 15, 2019.

(51) Int. Cl. C08L 75/04; A01M 29/30; B05D 1/02; C08L 75/02; H02G 3/08

(52) U.S. Cl. CPC C08L 75/04; A01M 29/30; C08L 75/02; H02G 3/081; B05D 1/02; C08G 2190/00

(57) ABSTRACT

An electrical control box for outdoor use that has a number of sealants provided to help prevent moisture from causing corrosion to the components inside the box, as well as providing resistance to attack of the box by critters, such as raccoons, mice, and the like. In some embodiments, a curable polyurethane is used.

### CROSS-REFERENCE TO RELATED APPLICATION

This application is a continuation of copending U.S. patent application Ser. No. 18/394,210 filed Dec. 22, 2023, which is a continuation of U.S. patent application Ser. No. 17/065,692 filed Oct. 8, 2020, and claims the benefit of U.S. Provisional Patent Application No. 62/887,318 filed Aug. 15, 20219, each of which is hereby incorporated.

### BACKGROUND OF THE INVENTION

### Field of the Invention

Critter resistant control boxes, more specifically, control boxes and modifications thereof, such as outdoor electrical control boxes at railroad crossings that, in some embodiments, help prevent access to the interior thereof by critters, such as insects and rodents, while, in some embodiments, providing corrosion resistance.

### Description of the Related Art

Electrical enclosures usually have cables running into and out, as well as access doors, all providing potential ingress locations for critters.

Rodents, insects, and other animals (collectively “critters”) do not mix well with electrical control boxes. They can get into small spaces looking for food or shelter, and rodents, like skunks, mice, and squirrels, or other animals can often chew through cables with their sharp teeth.

While some solutions, like fencing an area around an electrical control box or other electrical enclosure, have been tried, the results have had only limited success as some critters can crawl, climb. dig or fly.

Critters not only do physical harm in attempting ingress to an electrical control box, their scratching, chewing, and even feces can accelerate chemical corrosion caused, in part, by moisture.

Moreover, control boxes are sometimes subject to the elements and the use of sealants to protect the electrical parts from elements such as moisture can help extend the life of the boxes. Last, plants and microbes can also damage electrical enclosures.

### SUMMARY OF THE INVENTION

The present invention in at least one embodiment is generally directed to a method of protecting an electrical control box having a housing, having a conduit opening with an electrical conduit therethrough and a door opening with a door adjacent thereto, the housing enclosing electrical terminals, wires or junctions, the method including injecting an uncured, two-part, 100% solids, mix of polyurethane or polyurea onto any of the housing, door opening, perimeter, or conduit, and allowing the mix to cure. The cured mix can be a polyurethane, elastomeric, and having a peel strength between 0.5 and 30 piw. The mix preferably cures to 90% of final hardness in 2 to 240 minutes, and the uncured mix preferably has a viscosity of between 1,500 and 45,000 cps.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a perspective view of an example of a railroad control box to which one or more of Applicant's sealant products may be applied in accordance with one implementation of the present invention;

FIG. 1A illustrates prior art weather stripping on a door opening of a railroad control box and FIG. 1B illustrates a cross-section of the perimeter of a door having prior art weather stripping and Applicant's sealant in accordance with one implementation of the present invention;

FIG. 2 shows an enclosure and a method of applying an uncured two part polymer to a surface or component thereof in accordance with one implementation of the present invention;

FIGS. 2A, 2B, and 2C show an electrical conduit and electrical wires opening into or onto which one or more of Applicant's sealants may be applied in accordance with one implementation of the present invention;

FIG. 3 shows an electrical terminal with or on which one or more of Applicant's sealants may be applied in accordance with one implementation of the present invention;

FIGS. 4A and 4B illustrate two views of a sealant gasket for use with a door closure perimeter in accordance with one implementation of the present invention; and

FIGS. 5A and 5B illustrate two different tape or rolled sealants that may be used to help seal critter access to an electrical enclosure; FIG. 5A a stretchable tape and FIG. 5B a non-stretchable tape in accordance with one implementation of the present invention.

The use of the same reference symbols in different drawings indicates similar or identical items.

### DESCRIPTION OF THE PREFERRED EMBODIMENT(S)

FIGS. 1, 2 and 3 show enclosure(s) 10, comprising a walled housing 12 and, in some embodiments, a door 14, and a door opening perimeter 15, which may include an OEM foam seal 15A (see FIG. 1A), such as weather stripping. The walled housing 12 may include a conduit opening 16 or other opening with a wire bundle (see FIG. 2C) or conduit 18 passing through, typically leaving a small gap “G” between the walls defining the conduit opening 16 and the outer walls of conduit 18 or other insulated electrical wire, wires or wire sheaths.

Enclosure 10 defines an inner volume or space in which various electrical terminals 20, switches or other devices, in some embodiments, useful with or for railroad (“RR”) switching, junctions PTC (Positive Train Control), crossing gates, or other external boxes or enclosures. These enclosures are typically found outside and thus are subject to assault by pernicious critters seeking food or shelter and by dust, dirt or moisture.

Applicant's several sealant products and devices, alone or in combination, can help provide a physical barrier to critter ingress, a chemical aversion agent to said critters, an anti-microbial biocide agent, and also, in some embodiments, provide corrosion protection to the enclosure 10 or any parts on or in the enclosures.

A first sealant device is a gasket 22 (example, FIG. 2), a second device is a cure-in-place applicator injected polymer 28 composition (example, FIG. 3), a third device is a thin coat 40 of a brush 44, roller 48 applied, or spray gun 46 on cure-in-place polymer composition (example, FIG. 2), and a fourth device is a tape 42 (examples, FIG. 5A and 5B).

All of the foregoing have in common a two-part polymer matrix 24 that is either pre-cured (tape and gaskets) or cures-in-place on the substrate (injected and brush, roll or spray on coating). The polymers, once cured, are somewhat elastomeric, compressible, have hardness of a variety of ranges, adhere well (peel strength) to the metallic and/or non-metallic substrates (but do not adhesively bond to these substrates), and they seal well against ingress of moisture, they stand up to acids, bases, salts, and other structural corrosive agents. Moreover, the polymers may include a chemical aversion agent, such as a rodentcide or a critter repellant. The polymer may also contain anti-microbial (biocide) agents. In preferred embodiments, they have no VOCs (100% solids), and as such (no solvents) are considered non-hazardous. They do not require special shipping or handling and are non-combustible.

The gaskets and tapes, in some embodiments, have pre-cured polymer gel bodies and also an embedded, stretchable or substantially un-stretchable skeleton 26, which may be a webbing, mesh or foam (typically at least a partly open cell foam). Webbing, skeleton or mesh may be metallic or non-metallic, woven or non-woven, in preferred embodiments, non-metallic, including nylon, Kevlar®, and fiberglass webbing or mesh. DuraFlow® Kevlar mesh is one that may be suitable. In a preferred embodiment, the skeleton 26 is electrically non-conductive, strong, and tough but also may be conductive. The elastomeric polymer matrix typically encapsulates the skeleton. Another tough, durable rodent impenetrable mechanical barrier that may be used as a skeleton is a rodent control fill fabric called XCluder®, a combination of stainless steel and polyester fibers similar to steel wool.

Gaskets 22 are typically die cut and are seen to be used either on top of (FIG. 1B) or in place of weather stripping (FIG. 1A) or around conduit opening 16 (FIG. 2A) or any other suitable location usually between two parts under compressions. On door perimeter 15A, it will seal against the door edge (FIG. 1B), with the polymer surface depressing somewhat when the door is in a closed position, this creates a moisture and dirt tight seal (see FIG. 1B). The proper thickness of the gasket is selected to ensure contract and some deformation or indentation of the polymer as the door reaches closure. Typical thicknesses of gaskets and tape are in the range of 5-500 mil (uncompressed) (in other embodiments, 20-50 mil).

Tapes 42 (see FIGS. 5A and 5B) are similar to gaskets—in some embodiments having skeleton, and polymer matrix, but instead of being die cut, they come rolled up and are typically long, compared to width, and, in some embodiments, used to wrap conduits or other electrical wires, for helping to fill around gaps where the conduit enters an enclosure (FIG. 2B). In some embodiments, the tapes have a stretchable, polymer filled (typically saturated) foam skeleton (FIG. 5A), the cured polymer may, in some embodiments, be tacky to the touch, it will both compress somewhat but fill the gap (see FIG. 2B) and when stretched somewhat and wrapped around the electrical wire(s) in overlapping courses (see FIG. 3) will provide pressure to seal against the walls defining conduit opening 16. The foam may be open-cell or partially open-cell foam, the cells typically having pre-cured, tacky polyurethane. Some tapes contain a tough, durable skeleton (see FIG. 5B). In some embodiments, tape 42 self-amalgamating (self-fusing) tape, such as silicone-rubber tape which when stretched and wrapped around cables unites itself into a strong, seamless, rubbery, waterproof, electrically insulating layer (FIG. 3), showing both external and internal use of tape as well as using tape to close gap “G”.

FIG. 2A illustrates a pair of flat gaskets 22, one on an outside surface, the other on an inside surface of walls adjacent conduit opening 16, with a cutout or slit in the gasket so the electrical conduit 18 can pass through the gasket, but the gasket will otherwise seal the gap.

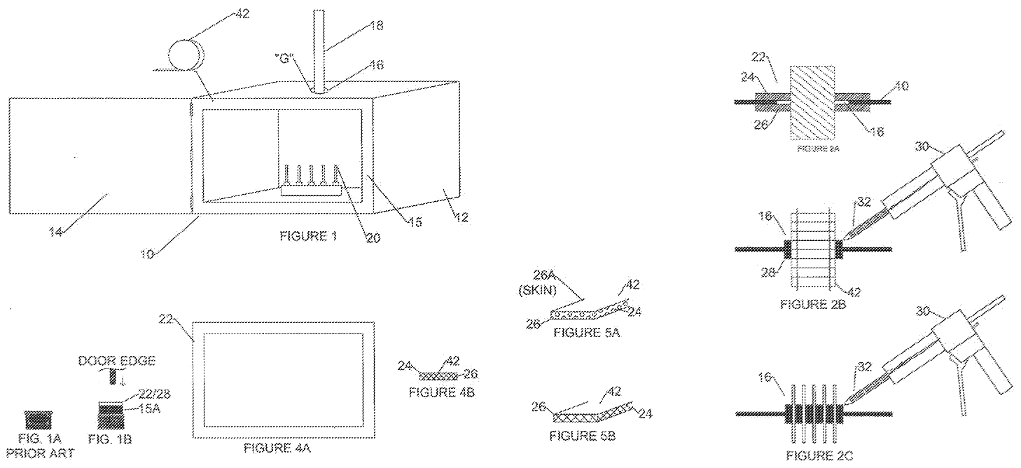

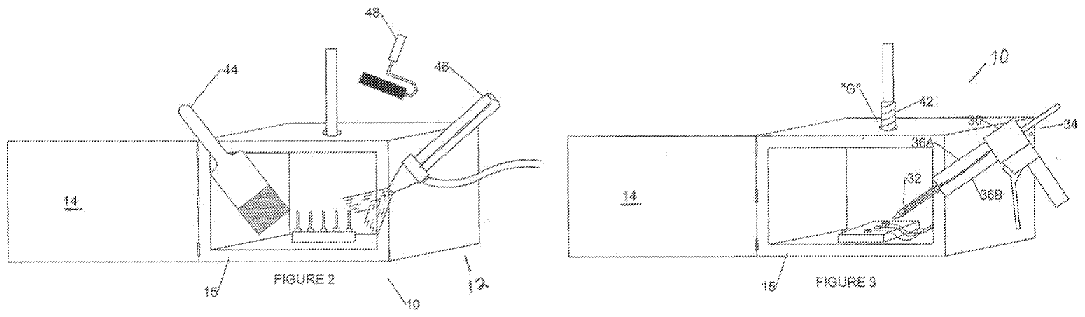

FIGS. 2, 2A, 4A, and 4B illustrate the shape of the gasket may be tailored to its use, here in FIG. 2A, a round or rectangular planar gasket shape to cover and stick to walls adjacent opening 16, or a rectangular gasket in FIGS. 4A and 4B, to fit door opening 15 and/or on OEM seal 15A. Tough and durable skeletons may be used, in some embodiments, that will stand up to the razor sharp teeth of mice. One side (typically facing out) of the gasket or tape may have a skin, such as a durable but flexible, impervious or semi-permeable, plastic or PTFE skin 26A, the tacky polymer side is usually against the structure.

FIGS. 2B, 2C, and 3 illustrate the use of Applicant's applicator or injector applied two-part CIP (cure-in-place) injectable polymer mix 28 to, in some embodiments, seal around electrical wires or conduits as they enter the enclosure. An apparatus, such as an applicator 30, having a mixing nozzle 32, and a plunger or forcing element 34, which acts on two compartments 36A/36B, each compartment having one (uncured) part of the two-part polymer, in some embodiments, the two-part polymer being a polyurethane or polyurea. As the forcing element 34 is manually pushed down, each polymer part will be forced into the mixing nozzle (also called a “mixing straw”) and will exit the tip to flow as a thick, viscous mass onto the device to be sealed, covered or encapsulated (FIG. 3) or into a gap to be filled (FIGS. 2B and 2C). The mix 28 typically will not sag on vertical surfaces (thixotropic) and may be shaped (formed) with the tip of the nozzle or with the user's fingers (before it cures). In some embodiments, the gel time of the mix is 1-10 minutes, and the cured hardness is between 40 to 90 Shore “00”, in other embodiments, greater than 60.

A number of chemical aversion agents can be used, mixed into one or both parts of the polymers before they are mixed to cure in place or pre-cured. These include peppermint oil, which acts as a safe rodent repellant and capsaicin (in some embodiments, as microcapsules). These aversion agents may kill the rodent (rodentcides, such as brodifacoum or arsenic compounds), or be merely distasteful, like Lithium Chloride.

A brushable, roll-on or sprayable cure-in-place polymer sealant coat 40 may be used to cover any part of the enclosure or component therein. It may be used as a brush-on, roll-on or spray-on in an uncured state, and, in some embodiments, cures clear, or at least transparent. It may be sprayed, rolled or brushed on any surface, external or interior, and often is used after injectables are used to coat the surfaces to prevent moisture from contacting the surfaces (see FIG. 2). It forms a tough, flexible, barrier to protect the substrate. It also may include a chemical aversion agent or anti-microbial agent. In some embodiments, it may gel in 1 to 14 minutes or less to a hardness of Shore “A” 30-90, in other embodiments, greater than 40 Shore “A”. The tape or gasket may be compressible, in some embodiments compressible to between 10% and 80% of its initial thickness at pressures between 2-10 psi.

The cure in place or precured polymer may contain ultraviolet (UV) light inhibitors such as carbon black particles loaded to 0.50-2% by weight of the mix. All polymers are preferably 100% solids (no volatiles). The polymer used is typically elastomeric when cured with a cured hardness between 30 and 95 shore “00” (injectables); 45-125 37.5-gram half cone penetrometer (the polymer gel bodies of the tape and gaskets) and 30-90 shore “A” (sprayable and injectables). All measured 24 hours after mixing at 77° Fahrenheit.

The injectables may be polyurea or polyurethane (two-part). The polyurea may have a peel-strength of 10-30 piw (pounds per inch width) (90° peel back off of clean aluminum), the polyurethane between 0.5 and 5 piw and is self-leveling. The injectable typically reach full cure in 2-240 minutes. The peel-strength of the sprayable may be 1-5 piw and the gel time 8 to 14 minutes (10-gram mass at 77° F.). The peel-strength of the tape may be 0.10-0.50 piw, and elasticity between 150-350%. Peel strength measured after full cure.

A spray cartridge is constructed like the applicator but, in come embodiments, is configured to engage a pneumatic spray gun such as a Sulzer 06114420-28 or 06114420-03 which provides mechanical rather than manual force to the forcing element and compressed air to the tip of the nozzle to atomize the mix as it comes out of the tip.

Biocides are provided in the polymer. One biocide is Vinyzene® SB-1 PR a concentrate of 10,10′-oxybisphenoxarsine. The pelletized form can be mixed with polymers. The biocide is mixed at 5% to 95% of the polymer. Vinyzene® is also available in 1% and 2% solutions in plasticizers and solvents. Other examples of biocides are Zinc Omadine manufactured by Olin Chemical, Zinc Tryithione; and Intercide TMP by Akzochemie America, N-trichloromethylthiophthalimide. These compounds are exemplary of the biocides which can be used in this invention and other biocides may be used. Other biocides may be found in U.S. Pat. Nos. 4,988,236 and 5,178,495 incorporated herein by reference.

Injectables may be two component cure-in-place applicator applied polyurea or polyurethane. One part may be resin, viscosity 18000-28000 cps, one part hardener, viscosity 25,000-42,000 cps (77° F.) for the polyurea. The uncured mix is a thick, viscous mass. The polyurethane resin is 1,500-2,500 cps and hardener is 3,300-4,300 cps, the uncured mix less viscous that the polyurea. Both pass ASTMB117, no corrosion after 3,000 hours in salt fog. The sprayable is a two-component polyurea that is even less viscous than the polyurethane injectable, passes the salt fog and 12-second vertical burn at 0.060″, 0.080″ and 0.235″ (14 CFR, part 25, subpart D, section 25.853(a) Appendix F, part 1A(1)(ii)).

Tapes may be skinned on one, none or all sides, and have low water absorption, in some embodiments, 1% or less, 168-hour immersion (ASTM D-543). Service temperature on all sealants are: −85° F. to +275° F. (except self-fusing tape) and shelf-life is indefinite.

In the preceding description, for purposes of explanation, numerous details are set forth in order to provide a thorough understanding of the embodiments. However, it will be apparent to one skilled in the art that these specific details are not required. In other instances, well-known structures and components are shown in block diagram form in order not to obscure the understanding.

Although the invention has been described with reference to specific embodiments, the above-described embodiments are intended to be examples only and are the description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A method of protecting an electrical control box having a housing, having a conduit opening with an electrical conduit therethrough and a door opening with a door adjacent thereto, the housing enclosing electrical terminals, wires or junctions, the method comprising the steps of:
injecting an uncured, two-part, 100% solids, mix of polyurethane or polyurea onto any of the housing, door opening, perimeter, or conduit; and
allowing the mix to cure.

2. The method of claim 1 wherein the cured mix is a polyurethane, is elastomeric, and has a peel strength between 0.5 and 30 piw.

3. The method of claim 2 wherein the mix cures to 90% of final hardness in 2 to 240 minutes.

4. The method of claim 2 wherein the uncured mix has a viscosity of between 1,500 and 45,000 cps.

5. A method of protecting an electrical control box having a housing, having a conduit opening with an electrical conduit therethrough and a door opening with a door adjacent thereto, the perimeter housing enclosing electrical terminals, exposed wires or junctions, the method comprising the steps of:
providing a precured polyurethane tape or gasket having an elastomeric polyurethane body and a skeleton, the body having a hardness of between 45 and 125 (37.5 gram half cone penetrometer); and
placing the tape or gasket adjacent or upon any of the housing, conduit, door opening perimeter or conduit.
